(19) United States
(12) Patent Application Publication
(10) Pub. No.: US 2015/0076939 A1
(43) Pub. Date: Mar. 19, 2015

(54) ROTARY MACHINE WITH DIRECT DRIVE

(71) Applicant: KRONES AG, Neutraubling (DE)

(72) Inventors: Bernd Schroll, Regensburg (DE); Roland Laumer, Regensburg (DE); Heinz Humele, Thalmassing (DE); Christian Stoiber, Michelsneukirchen (DE); Andreas Kraus, Lappersdorf (DE); August Peutl, Worth (DE)

(21) Appl. No.: 14/465,607

(22) Filed: Aug. 21, 2014

(30) Foreign Application Priority Data
Sep. 13, 2013 (DE) 102013218438.7

(51) Int. Cl. H02K 7/14; H02K 9/08; H02K 11/00; H02K 7/08; H02K 3/04

(52) U.S. Cl. CPC H02K 7/14; H02K 7/08; H02K 3/04; H02K 11/0015; H02K 9/08
USPC 310/54; 310/67 R

(57) ABSTRACT

Rotary machine, in particular container treatment machine, including a rotating part which has several treatment stations, and a stationary part, the rotating part and the stationary part are embodied such that they together form the drive of the machine, the rotating part forming the rotor and the stationary part forming the stator of an electric motor.

### CROSS-REFERENCE TO RELATED APPLICATION

The present application claims priority to German Application No. 102013218438.7, filed Sep. 13, 2013. The priority application, DE 102013218438.7, is hereby incorporated by reference.

FIELD OF THE DISCLOSURE

The present invention relates to a rotary machine, in particular the drive of a rotary machine.

PRIOR ART

Rotary machines, for example those in the beverages processing industry, are well-known. For example, there are stretch-blow molding machines or labeling machines as well as direct printing machines for treating containers which are embodied as rotary machines and thus may operate continuously and/or discontinuously. The connection between the rotary or the rotating part of said rotary machines is often realized via ball bearing slewing rims. The latter comprise toothings, so that a connection to a servomotor, which will then drive the corresponding carousel, may be established, for example via a pinion. However, since in many cases very complicated transmission systems are used and for a carousel, even multiple servomotors for the drive are sometimes provided, malpositions may occur in particular due to a gear backlash. This makes it difficult to meet the high demands on precision, in particular during the labeling and printing of containers. Furthermore, the lubrication of the bearings in which the carousel is guided and of the toothings is very complicated, and a large installation space for accommodating the complete drive system is required.

### SUMMARY OF THE DISCLOSURES

Starting from prior art, it is therefore the object of the present invention to provide a precise and simultaneously highly flexible drive system for a rotary machine.

The rotary machine according to the invention is characterized in that the rotating part and the stationary part are embodied such that they together form the drive of the machine, the rotating part forming the rotor and the stationary part forming the stator of an electric motor. With this direct drive, a drive of the rotating part of the container treatment machine or rotary machine may be accomplished in a technically simple manner, and a high-maintenance transmission can be eliminated. Furthermore, rotation may be adjusted much more precisely thus clearly improving the achieved treatment results.

In the aforementioned embodiment, the stator is part of the construction that supports the machine. According to a further embodiment, the stator might therefore be arranged further to the inside, closer to the central axis of the rotary machine and thus be provided separately from the construction supporting the machine. The supporting construction is in this embodiment then preferably disposed radially outside, i.e. radially further away from the central axis of the rotary machine than the stator. This construction supporting the machine may equally be embodied as hollow cylinder, or it may be embodied as single segments/supports arranged around the central axis of the rotary machine. Since the stator in this case no longer has a supporting function, it may be more easily removed, for example from above through the rotor, and in particular, the complete construction of the stator may be embodied to be lighter. It is here particularly advantageous for the stator to have a multipart design, so that a removal of the individual parts of the stator may be accomplished without many efforts.

In another embodiment, however, it may also be provided for the construction supporting the machine to be embodied further to the inside closer to the central axis of the rotary machine, thus being provided separately from the stator. The stator is in this embodiment then preferably arranged at the same place. In this embodiment, the stator is then preferably arranged radially outside, i.e. radially further away from the central axis of the rotary machine than the construction supporting the machine. The construction supporting the machine may equally be embodied as hollow cylinder, or it may be embodied as single segments/supports arranged around the central axis of the rotary machine. Since the stator in this case no longer has a supporting function, it may be more easily removed, for example from above through the rotor, and in particular, the complete construction of the stator may be embodied to be lighter. It is here particularly advantageous for the stator to have a multipart design, so that a removal of the individual parts of the stator may be accomplished without many efforts.

In one embodiment, the stationary part and the rotating part each comprise a cylindrically embodied region, the cylindrical regions being embodied such that they engage each other, and the stationary part in the cylindrical region comprising at least one electromagnet and the rotating part in the cylindrical region comprising at least one magnet. By the selection of the dimensions of the correspondingly cylindrical regions, an ideal ratio between the size of the cylindrical regions on the one hand and the achieved positional accuracy when the rotary machine is being rotated on the other hand may be achieved.

Furthermore, the rotating part may be connected to the stationary part via a bearing, the bearing being or comprising either a thin section bearing, a wire bearing, a pretensioned bearing which is preferably free from backlash, or a four-point moment bearing element without any bearing rings. The embodiment of the bearing according to some of these embodiments brings about the corresponding advantages. Either bearings that require lubricants or bearings that do without lubricants may be used.

The power supply for supplying the electromagnets might be guided to the electromagnets in the stationary part. Thus, the power supply may be guided through the rotary machine and thus be protected from environmental influences, for example moisture.

According to one embodiment of the rotary machine, the electromagnet is embodied as a coil extending around the entire periphery of the stator. While said coil might thus be a very large component, it may be relatively easily replaced in case of a malfunction since the complete coil may be removed as one component.

According to one embodiment of the rotary machine, the electromagnet consists of at least one partial segment, where several individual partial segments may be embodied across the complete periphery of the stator. The electrical connection of the individual segments may be realized, for example, by means of plug connectors. The replacement in case of a malfunction is relatively easy since individual segments may be removed radially to the outside.

In one embodiment, the rotary machine is characterized in that the rotating part comprises a cover which extends at least over the magnet and at least partially insulates the cylindrical regions from the surrounding area. It may thus be ensured that both the bearing and the electric components are protected from environmental influences and maintenance and cleaning operations must be performed less frequently.

In another embodiment, a shaft encoder is provided which is suited to measure the speed and/or rotational speed and/or rotational position at the rotating part of the rotary machine. Since said shaft encoder may directly measure the speed or rotational speed of the rotating part, a more precise speed determination and position determination results, compared to measuring methods known from prior art.

In one advantageous further development, a lubrication line is provided which is connected to the bearing and is suited to supply lubricant to the bearing. It may thus be ensured that wear at the bearing is as minimal as possible.

In one embodiment of the rotary machine, the cylindrical regions are embodied as hollow cylinder jackets. In this manner, an economical and clearly lighter construction of the rotary machines can be realized.

It is advantageous to provide a cooling unit which is suited to cool the bearing and/or the electromagnet and/or the magnet by heat exchange with a cooling medium. If both the stator and the rotor are permanently cooled, and if the bearing is also cooled, undesired malfunctions or wear or destructions of the individual components due to the always constant temperature may be avoided.

The cooling medium might be a gas or a liquid. While gas cooling is inexpensive and not very susceptible to failures, liquid cooling has the advantage that, due to the high thermal capacity of the liquid and the better heat exchange, more effective cooling may be realized.

Moreover, passive cooling may also be provided, e.g., cooling ribs/vanes, i.e. geometries having a large surface and a thermally well conductive material which is cooled by convection and/or radiation.

Furthermore, the rotary machine may be characterized in that the cylindrical region of the rotating part comprises a circular disk on which at least one magnet is arranged. In this embodiment, the overall size of the cylindrical region of the rotating part may be reduced, and the rotating part may be placed, for example, onto the stationary part. The required rotatable bearing of the rotor may be realized by a corresponding bearing.

In one embodiment of the rotary machine, the rotating part is embodied to engage the stationary part, or the stationary part is embodied to engage the rotating part.

According to one embodiment, the rotary machine may be a labeling machine, a stretch-blow molding machine, a direct printing machine, or a filler. These may be machines which both produce containers (preform injection molding machine) and treat containers. The embodiment of the rotary machine as one of such machines permits to benefit from the above described advantages in the corresponding manufacturing and treatment steps for containers.

### BRIEF DESCRIPTION OF THE FIGURES

FIG. 1a is a schematic representation of a rotary machine according to the invention, in particular a stator and a rotor, in cross-section;

FIG. 1b is a schematic representation of the rotary machine of the present disclosure, in particular a stator and a rotor, in cross-section;

FIG. 2 is a schematic representation of the connection between the stator and the rotor; and

FIG. 3 is a schematic representation of a rotary machine according to a further embodiment.

### DETAILED DESCRIPTION

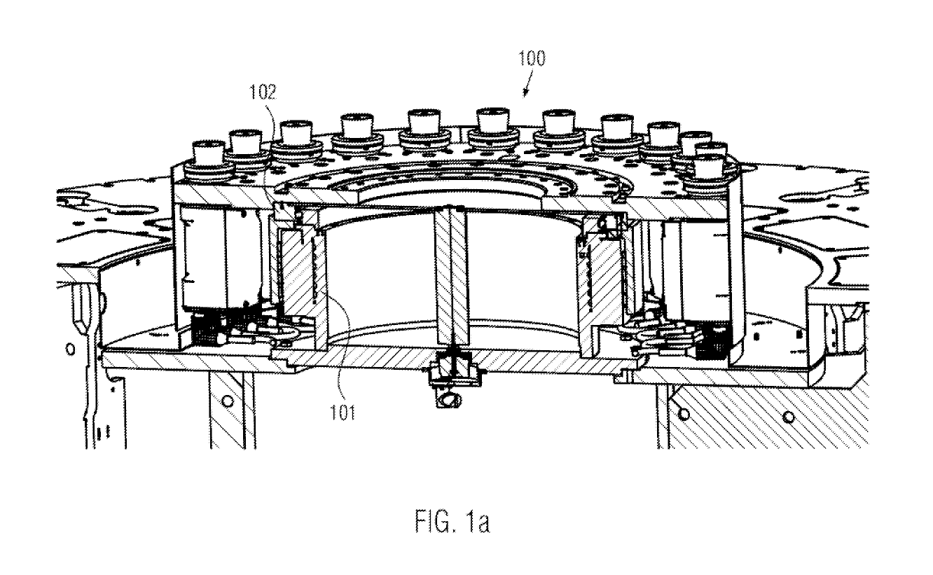

FIG. 1a shows a rotary machine 100 according to the invention. It comprises a stationary part 101 and a rotating part 102. Typically, container treatment stations or container clamping stations or elements for fixing the containers or container transport elements are arranged on the rotating part 102. Depending on the embodiment of the rotary machine 100, these may strongly differ. By way of example, the rotating part in a direct printing machine comprises several container treatment stations or container clamping stations. The latter may comprise, for example, individual rotary plates and printing modules associated with them. At the stationary part 101 of the rotary machine, further components may be arranged, for example, ink storage tanks, labeling or printing units, or the like, depending on the design of the rotary machine. Here, most diverse embodiments are already known which may depend on the type of the container treatment machine.

Basically, the stationary part 101 and the rotating part 102 are interconnected via a bearing, so that the rotating part 102 rests on the stationary part 101. By a corresponding drive unit, the rotating part 102 may then be caused to rotate relatively to the stationary part 101.

FIG. 1a illustrates shows a design of the stationary part 101 and the rotating part 102 according to the invention. According to the invention, the stationary part of the rotary machine forms the stator, and the rotating part 102 of the rotary machine forms the rotor of an electric motor. This is achieved, for example, by arranging electromagnets in the stator 101 which may generate electromagnetic alternating fields by correspondingly controlling them. In the rotating part 102, magnets are provided. By the electromagnetic interaction between the electromagnets and the magnets in the stator respectively rotor 102, the rotor 102 is then caused to rotate relatively to the stator 101. Here, it is advantageous that any additional gears or transmissions may be eliminated, and the speed or rotational speed of the rotor 102 (equivalent to the rotating part 102) may be achieved directly by changing the power supply to the electromagnet in the stator 101. Since the transmission of the electromagnetic force is not coupled to the direct physical contact, the electromagnets or magnets in the stator and rotor could be in principle arranged as desired. Accordingly, they do not have to be arranged directly adjacent with respect to each other. However, it may be advantageous to arrange these components as close as possible to a bearing in which the rotor 102 is guided around the stator 101. The bearing 103 may have many different designs. Advantageously, the bearing is embodied as thin section bearing. Equally, a wire bearing or a pretensioned bearing which is preferably free from backlash may be used. A four-point moment bearing element without any bearing ring is particularly advantageous. Here, the inner ring and the outer ring of the bearing are separated by rolling bodies, in particular balls. In this case, four separate rails are provided for these balls in which they may be guided. Due to the bearing with balls, the use of such a four-point moment bearing element is particularly preferred because less wear occurs.

As is represented in FIG. 1b, both the stator 101 and the rotor 102 are embodied as at least partially cylindrical components or as components which comprise a cylindrical region. Said components directly engage each other in one embodiment, as is shown in FIG. 1b. Thus, an additional fixing beyond the bearing 103 is provided, since the outer surface of the stator 101 and the inner surface of the rotor 102 (the corresponding surface areas) here ensure a restriction of free motion. This embodiment may be furthermore advantageously utilized for protecting the sensitive components of this direct drive (in particular the electromagnets) from harmful environmental influences, for example moisture. The rotor 102 which, in the embodiment shown in FIG. 1b, grips around the stator 101, here acts as a corresponding shielding. The rotor 102 might also be embodied such that it engages with the stator 101.

However, the embodiment in which the rotor 102 grips around the stator 101 is preferred since in this way, the guidance of lines inside the stator 101 is possible. For example, a shaft encoder 104 might be arranged in the interior and be connected to the rotor 102 or be at least embodied to be able to measure the rotary motion of the rotor 102. In this manner, the speed or rotational speed and/or the rotational position of the rotor 102 may be directly measured at any time by the shaft encoder 104 without the need for any indirect measurement via the speed measurement of an additionally connected motor or via a speed measurement of a transmission. The direct measurement with the shaft encoder 104 therefore permits a very precise measurement of the motion parameters of the rotor 102. Furthermore, e.g., the lubricant supply 105 and/or the power supply 107 might also be guided through the inner region of the stator 101, and thus the electromagnets of the stator 101 may be supplied with power and the bearing with lubricant. In this context, it is advantageous for the stator 101 to be embodied as hollow cylinder or as hollow cylinder jacket and to preferably have thin walls, however without significantly affecting the supporting capacity of the stator 101. The larger the free interior of the stator 101, the more sensitive components may be accommodated here. Since this region is protected against environmental influences by the rotor 102, a space-saving accommodation of sensitive components may be ensured.

In the represented embodiment, the stator 101 is part of the construction supporting the machine. So, problems at the stator, for example malfunctions of the electromagnets, require a complete reconstruction of the machine to replace or repair corresponding components. According to one embodiment, the stator 101 might therefore be arranged further to the inside, closer to the shaft encoder 104 or the central axis of the rotary machine and be thus provided separately from the construction supporting the machine. The supporting construction is in this embodiment then preferably arranged at the same place (hence at the place where the stator is shown in FIG. 1a and FIG. 1b). Analogously, however, the construction supporting the machine might be arranged further to the inside, closer to the shaft encoder 104 or the central axis of the rotary machine and thus be provided separately from the stator 101. The stator 101 is in this embodiment then preferably arranged at the same place (cf. FIGS. 1a and 1b). Since the stator 101 in both variants no longer has any supporting function, it may be more easily removed, for example from above through the rotor 102, and in particular, the complete construction of the stator may be embodied to be lighter. It is here particularly advantageous for the stator 101 to have a multipart design, so that a removal of the individual parts of the stator 101 may be accomplished without many efforts.

In another embodiment, the stator 101 may also be realized outside the rotor 102 by installing the electromagnets, for example, in pylons surrounding the stator 102 which are connected to the stationary part of the rotary machine (in particular a fixed table). The rotor 102 is then arranged within said stator whereby the individual components of the stator can be better accessed. This embodiment also permits an easy adaptation of the efficiency of the device since optionally further pylons with electromagnets may be attached. For example, in one embodiment, four pylons may be provided which are arranged symmetrically in a concentric region around the rotor 102. In another embodiment, 8, 12 or 16 pylons, or any other number of pylons may be provided.

Although the rotating part 102 is here identical as a whole to the rotor, and the stationary part 101 to the stator, a two-part or multipart design may also be realized. In such an embodiment, the rotating part 102 may comprise a rotor or a rotor region 102a and a bearing region 102b in which, for example, a part of the guidance for the bearing 103 is arranged. These may be embodied as separate, but interconnected components. For example, the rotor 102a may be provided as a ring which is connected to the bearing region 102b or the other part of the rotating part 102, for example by a screwed joint. This offers the advantage that in case of maintenance or repair operations, it is not necessary to replace the complete rotating part 102 of the rotary machine 100, but it may rather be sufficient to disassemble the rotor 102a. Analogously, the stationary part 101 may also be designed in two or more parts, where the stator 101a may be provided as a separate component which may be connected with the bearing region 101b of the stationary part 101 corresponding to the bearing region 102b. The two-part design of the stationary region furthermore offers the advantage that the power supply 107 and the lubricant supply 105 may be guided to the respective regions. Thus, in case of maintenance operations, it is not necessary, for example, for removing the bearing to disassemble the complete power supply to the electromagnets and vice versa. It is then sufficient to optionally interrupt the lubricant supply 105 when the bearing must be replaced or corresponding maintenance operations must be performed.

Furthermore, a cooling system 106 might be associated with the stator 101, which cooling system may introduce a cooling medium into the stator 101 or at least cause cooling in such a way that the electromagnets of the stator 101, the magnets of the rotor 102, and the bearing 103 are cooled. It is advantageous for the cooling system to be embodied such that these three assemblies may be cooled simultaneously. It is to this end particularly advantageous for the magnets and electromagnets to be arranged as close as possible to the bearing. The cooling system, however, may also consist of three individual cooling systems (electromagnet cooling, magnet cooling, bearing cooling), these being in this case preferably embodied and activated separately).

The cooling system may in principle be of any design, however gas cooling or liquid cooling, for example with water, offers itself. For this, corresponding pipelines and channels may be guided through the stator 101 which distribute the cooling medium in the latter. Since liquid cooling must meet particular demands when it is used for cooling electronic components, only an indirect heat exchange might be accomplished via a partition (for example a thin wall of aluminum or a similar material) if liquid cooling is employed. Thus, a heat exchange between the electromagnets and the cooling unit 106 may be accomplished and simultaneously, the risk of damages and short-circuits may be reduced, preferably avoided. In addition to this cooling unit, a further cooling unit or the same cooling unit may be provided to also cool the interior of the stator 101 in which, as was already mentioned above, sensitive assemblies, such as control units or electronics, may be arranged. Furthermore, lubricant may be permanently supplied to the bearing 103 via a corresponding conduit, so that the arising abrasion and frictional effects are minimized, thus increasing the energy efficiency of the rotary machine.

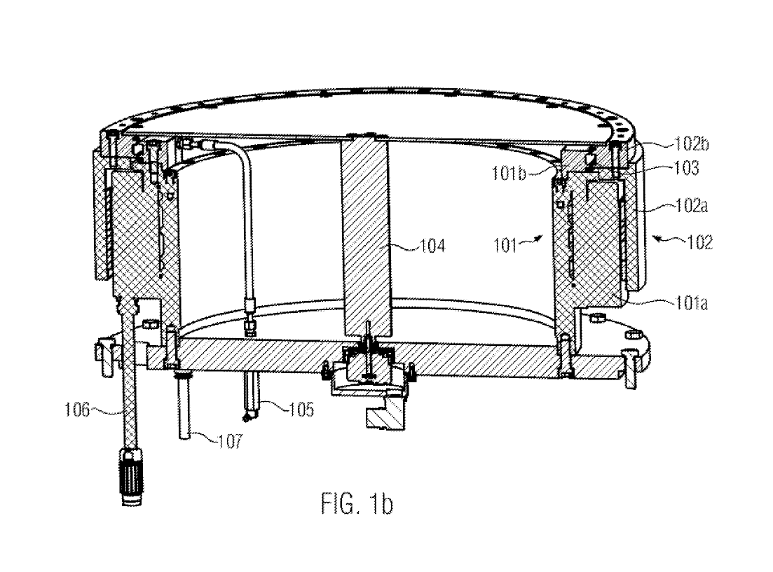

While the arrangement of the magnets and electromagnets in the stator and rotor is basically arbitrary, it may be advantageous to arrange the magnets and electromagnets as close to each other as possible. In this respect, FIG. 2 shows a possible embodiment of the stator and the rotor or the stationary part 101 and the rotating part 102 of the rotary machine. In the embodiment represented here, the stator 101 comprises one or several electromagnets 210 which are arranged, for example, along the periphery of the cylindrical part of the stator 101 shown in FIGS. 1a and 1b. Here, a plurality of individual and individually activated electromagnets 210 may be distributed across the entire periphery of the stator 101. However, a coil which extends around the entire periphery or a region of the stator might also be inserted. As is shown in FIG. 2, the magnets 220 of the rotor 102 are directly adjacent to the electromagnets 210. Since the field strength of electromagnetic fields decreases as the distance increases, this arrangement of the magnets and electromagnets is particularly preferred because hardly any losses occur when the distance between the electromagnet and the magnet only amounts to a few millimeters. The embodiment represented in FIG. 2 is also characterized in that the electromagnets 210 of the stator 101 or the magnets 220 of the rotor 102 of the bearing 103 are directly adjacent. Furthermore, the power supply supplies the electromagnet 210 with power. If only one continuous coil which is fixed to the stator 101 is provided, one single power supply is sufficient. If a plurality of separate electromagnets 210 is provided, several lines may originate from one central power supply and supply the individual electromagnets with power, or one connection may be realized between the individual electromagnets via current-bearing lines, in which case power supply from only one central power source would be also conceivable. The region 221 between the magnets 220 and the electromagnets 210 is preferably filled with air. Since the individual components, the stator 101 and the rotor 102, do not have to be separated in an air-tight manner from the surrounding area, this air may also be normal ambient air. However, it may also be advantageous for the refrigerator to be suited, if gas cooling is used, to introduce air into this intermediate region for cooling. Thus, the surface of the magnets and electromagnets may also be cooled at this side.

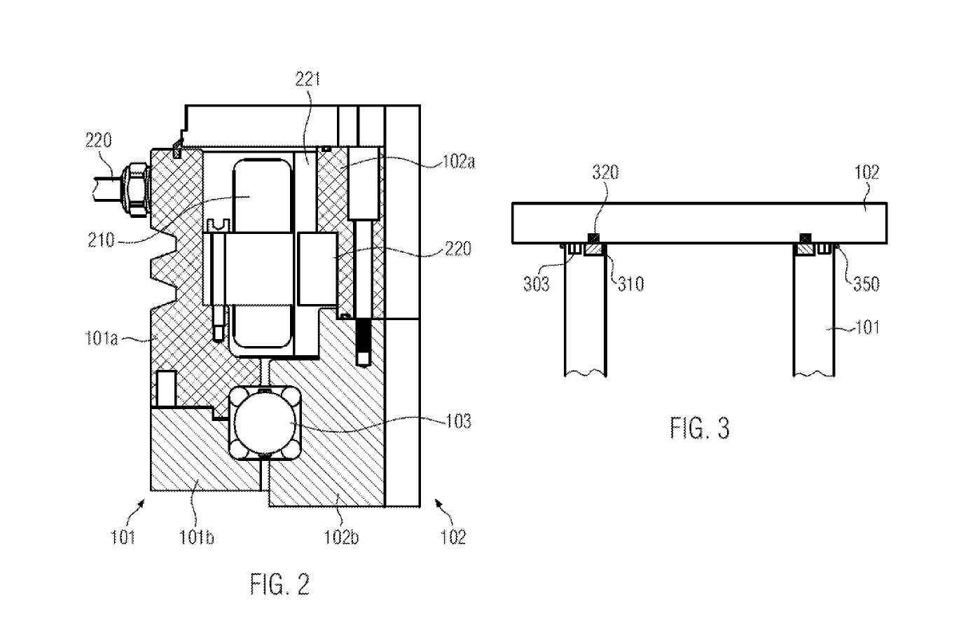

FIG. 3 shows another embodiment in which the stator 101 is not completely surrounded by the rotor 102, and in which the rotor 102 is embodied as circular disk. In this case, the electromagnets 310 of the stator 101 are not arranged laterally, but on the upper edge of the stator 101. The same applies to the guidance 303, although it may also be attached laterally and may form a connection to the stator 101 via a corresponding extension of the rotor 102. The magnets 320 of the rotor 102 are arranged on the side facing the stator 101. To protect both the bearing and the electromagnets and magnets from harmful environmental influences, a ring seal 350 may be provided to the outside which shields the inner region of the stator 101 from the surrounding area. However, as shown in the previous embodiments, an extension of the rotor 102 in the form of a cylinder jacket which grips around the stator 101 from outside may be provided. Such contactless shielding is basically preferred.

Since frictional losses caused by the bearing are relatively low and the generated electromagnetic fields may be directly used for driving the rotor 102 in all embodiments, it is sufficient for the electromagnets in the stator 101 to form alternating fields with a maximum flux density of 1 T, so that the rotor 102 may be caused to rotate. To reduce the required flux density, a plurality of assemblies might be arranged on the stator or a fixed table or an additional component, so that the rotor 102 may be designed to be as light as possible, thus reducing the required amount of energy for driving it.

The drive for rotary machines introduced here may be basically used for all container treatment machines, in particular also for preform injection molding machines by which plastic preforms for the manufacture of containers may be produced, and stretch-blow molding machines which may process these preforms e.g., into bottles. Furthermore, a corresponding drive may be employed in fillers, closers, rinsers and inspection machines for empty and/or filled bottles. The use of these drives is particularly advantageous for labeling machines and for container distribution and/or orientation machines and for direct printing machines as the employed direct drive permits a very precise control of the motion of the rotor. This is advantageous exactly in the direct printing of containers because in this case, a very precise alignment of the containers relative to the individual printing modules is necessary. With the direct drive according to the invention, a corresponding positioning to a few millimeters up to a few hundredths or tenths of millimeters may be achieved which clearly improves the quality of the attached printed images.

What is claimed is:

1. A rotary machine comprising a rotating part which comprises at least one treatment station, and a stationary part, the rotating part and the stationary part embodied such that they together form the drive of the machine, the rotating part forming the rotor and the stationary part forming the stator of an electric motor.

2. The rotary machine according to claim 1, the stationary part and the rotating part each comprising a cylindrically embodied region where the cylindrical regions are embodied such that they engage each other, the stationary part in the cylindrical region comprising at least one electromagnet and the rotating part in the cylindrical region comprising at least one magnet.

3. The rotary machine according to claim 1, the rotating part being connected to the stationary part via a bearing, the bearing being or comprising one of a thin section bearing, a wire bearing, a pretensioned bearing, or a four-point moment bearing element without a bearing ring.

4. The rotary machine according to claim 2, the power supply being is guided in the stationary part to the electromagnets for supplying the electromagnets.

5. The rotary machine according to claim 2, the electromagnet being embodied as a coil extending around at least a partial periphery of the stator.

6. The rotary machine according to claim 1, the electromagnet comprising at least one partial segment, where several individual partial segments may be embodied across the entire periphery of the stator.

7. The rotary machine according to claim 2 the rotating part comprising a cover which extends at least over the magnet and at least partially insulates the cylindrical regions from the surrounding area.

8. The rotary machine according to claim 1 and a shaft encoder is provided which is suited to measure at least one of the speed, the rotational speed, or the rotational position at the rotating part of the rotary machine.

9. The rotary machine according to claim 1, and a lubricant supply is provided which is connected to the bearing and is suited to supply lubricant to the bearing.

10. The rotary machine according to claim 1 the cylindrical regions embodied as hollow cylindrical jackets.

11. The rotary machine according to claim 1, and a cooling unit is provided which is suited to cool at least one of the bearing, the electromagnet, or the magnet by heat exchange with a cooling medium.

12. The rotary machine according to claim 11, the cooling medium being one of a gas or a liquid.

13. The rotary machine according to claim 2, the cylindrical region of the rotating part comprising a circular disk on which the at least one magnet is arranged.

14. The rotary machine according to claim 1 and the rotating part is embodied so as to engage in the stationary part.

15. The rotary machine according to claim 1 and the rotary machine is embodied as one of labeling machine, a stretch-blow molding machine, a direct printing machine, a closer, a rinser, an inspection machine or a filler

16. The rotary machine according to claim 1 and the stationary part is embodied so as to engage in the rotating part.
